(19) United States
(12) Patent Application Publication
(10) Pub. No.: US 2016/0230862 A1
(43) Pub. Date: Aug. 11, 2016

(54) DISENGAGEABLE LEAD SCREW NUT

(71) Applicant: Schaeffler Technologies AG & Co. KG, Herzogenaurach (DE)

(72) Inventor: Jason Hoover, Charlotte, NC (US)

(73) Assignee: Schaeffler Technologies AG & Co. KG, Herzogenaurach (DE)

(21) Appl. No.: 14/618,332

(22) Filed: Feb. 10, 2015

(51) Int. Cl. F16H 25/20

(52) U.S. Cl. CPC F16H 25/2025

(57) ABSTRACT

A disengageable lead screw nut assembly for a lead screw assembly is provided. The disengageable lead screw nut assembly includes a housing, and first and second electromagnets mounted on opposing sides of the housing. First and second lead screw nut parts are arranged in proximity to the respective first and second electromagnets, the first and second lead screw nut parts are movable between a first, lead screw engagement position, and a second, disengaged position. Springs are located in the housing that bias the first and second lead screw nut parts toward one of the first and second positions, and the lead screw nut parts are movable against a force of the respective springs to the other of the first and second positions upon activation of the electromagnets. In the first, lead screw engagement position, a lead screw engagement path is defined between the first and second lead screw nut parts.

### FIELD OF INVENTION

This application is generally related to lead screw arrangements that include a nut located on the lead screw that is connected to a carriage or other driven part that can be moved or positioned by rotation of the lead screw and more particularly, to a lead screw nut that is disengageable from the lead screw.

### BACKGROUND

Lead screws are known for use in various linear positioning devices and linear actuators in order to convert a turning motion into a linear motion. These are commonly found in linear actuators, machine slides, vices, presses, jacks, as well as other devices where controlled linear positioning movement is required. Lead screws can have various different thread types, such as square threads, V threads, or Acme threads, for example. Movement is transferred via the lead screw to a carriage or other device to be moved via a lead screw nut which is engaged with the lead screw threads and fixed to the carriage or other device. As the lead screw is turned, for example via an electric motor, the lead screw nut is translated, with the movement being controllable by the pitch of the threads and number of turns. Rotary encoders can also be provided on a shaft of the motor or on the lead screw in order to accurately control position.

In some applications, it is desirable to be able to quickly move or reposition a carriage or other device connected to a lead screw nut between first and second positions without being required to turn the lead screw. This so-called “quick” repositioning can only be accomplished by disengaging the lead screw nut from the lead screw in order to allow a sliding movement. One known prior art solution provided, for example as in U.S. 2009/0183585, a pair of split semi-screws that are resiliently retained inside a lead sleeve having inner threads. When the split semi-screws are in an open status, they engage the lead sleeve inner threads and allow movement. When the split semi-screw is in the closed state, the lead sleeve inner threads are not engaged and can be moved back and forth randomly in order to provide rapid distance adjustment. Another possible solution provided in U.S. Pat. No. 1,075,301 is a split lead screw nut that it adapted to be shifted into and out of engagement with a lead screw through a complicated locking system of notched disks and worm gearing. It would be desirable to provide a disengageable lead screw nut to allow for quick repositioning of a carriage or other article connected to a lead screw by disengaging the lead screw nut from the lead screw in a simple and reliable manner.

### SUMMARY

Briefly stated, a disengageable lead screw nut assembly is provided. The disengageable lead screw nut assembly includes a housing, preferably made of non-ferrous material, and first and second electromagnets mounted on opposing sides of the housing. First and second lead screw nut parts are arranged in proximity to the respective first and second electromagnets, the first and second lead screw nut parts are movable between a first, lead screw engagement position, and a second, disengaged position. Springs are located in the housing that bias the first and second lead screw nut parts toward one of the first and second positions, and the lead screw nut parts are movable against a force of the respective springs to the other of the first and second positions upon activation of the electromagnets. In the first, lead screw engagement position, a lead screw engagement path is defined between the first and second lead screw nut parts. Movement to the second, disengaged position allows a carriage or other part connected to the lead screw nut assembly to be quickly moved or repositioned without turning the lead screw.

In one arrangement, the springs bias the first and second lead screw nut parts to the first, lead screw engagement position and activation of the electromagnets moves the lead screw nut parts to the second, disengaged position.

In one arrangement, guide pins are mounted to the housing, and openings are provided in the lead screw nut parts in which the guide pins extend to define a movement path for the lead screw nut parts between the first, lead screw engagement position, and the second disengaged position.

In one arrangement, the first and second lead screw nut parts are mounted to respective first and second striker plates which are formed of a ferromagnetic material. The first and second nut parts can also be formed directly from ferromagnetic material.

In a preferred embodiment, the springs are wave springs located between the first and second lead screw nut parts and at least one of the respective first and second electromagnets or portions of the housing in which the first and second electromagnets are mounted.

In one arrangement, the housing is comprised of a first housing part and a second housing part that are connected at intermediate faces thereof. The first and second housing parts each include an electromagnet receiving cavity and a recess to receive the lead screw nut part.

A lead screw assembly is also provided. The lead screw assembly includes a lead screw arranged in the engagement path of the disengageable lead screw nut assembly as discussed above.

Additional preferred arrangements of the disengageable lead screw nut assembly having one or more features of the invention are described below and in the claims.

### BRIEF DESCRIPTION OF THE DRAWINGS

The foregoing Summary as well as the following Detailed Description will be best understood when read in conjunction with the appended drawings. In the drawings:

FIG. 1 is a perspective view of a disengageable lead screw nut assembly along with a lead screw.

FIG. 2 is a cross-sectional view through the lead screw nut assembly of FIG. 1 with the nut halves in the closed position.

FIG. 3 is a cross-sectional view through the lead screw nut assembly of FIG. 1 with the nut halves in the open position.

### DETAILED DESCRIPTION OF THE PREFERRED EMBODIMENTS

Certain terminology is used in the following description for convenience only and is not limiting. The words “inner,” “outer,” “inwardly,” and “outwardly” refer to directions towards and away from the parts referenced in the drawings. A reference to a list of items that are cited as “at least one of a, b, or c” (where a, b, and c represent the items being listed) means any single one of the items a, b, or c, or combinations thereof. The terminology includes the words specifically noted above, derivatives thereof, and words of similar import.

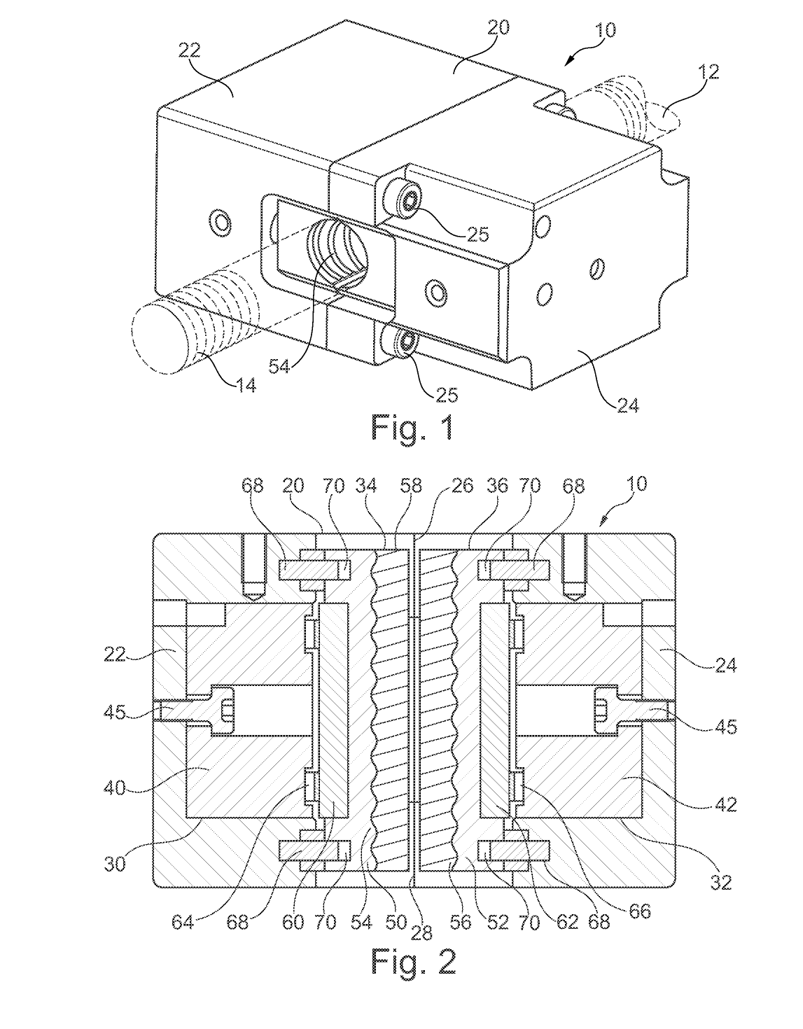

FIG. 1 shows a disengageable lead screw nut assembly 10 engaged over a lead screw 12 (shown in broken lines for clarity). This can be used, for example, in a linear actuator or linear positioning device. The lead screw 12 has external threads 14.

As shown in FIGS. 1 and 2, the disengageable lead screw nut assembly 10 includes a housing 20. The housing 20 is preferably made from a non-ferrous material, such as aluminum or a polymeric material. The housing 20 is comprised of a first housing part 22 and a second housing part 24 that are connected at intermediate faces 26, 28 thereof. The first housing part 22 and the second housing part 24 each include an electromagnet receiving cavity 30, 32 and an associated recess 34, 36, to receive respective lead screw nut parts 50, 52, discussed in further detail below.

First and second electromagnets 40, 42 are mounted on opposing sides of the housing 20, preferably in the first housing part 22 and the second housing part 24, respectively. The electromagnets 40, 42 are preferably held in position via fasteners 43, which can be threaded fasteners 45 to allow for easy disassembly for maintenance or replacement.

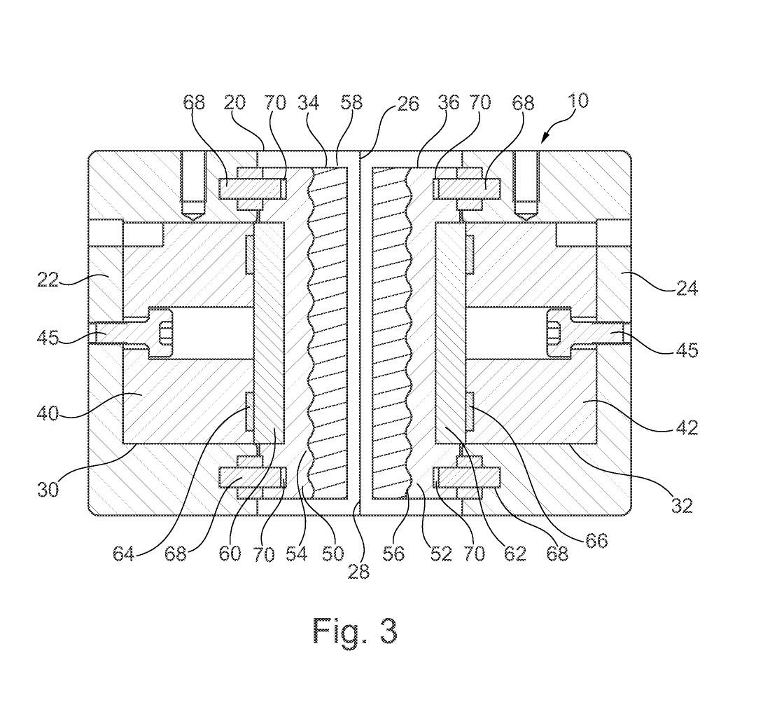

As shown in detail in FIG. 2, first and second lead screw nut parts 50, 52 are arranged in proximity to the first and second electromagnets 40, 42, respectively. The first and second lead screw nut parts 50, 52 include partial threads 54, 56 and are adapted to be movable between a first position, as shown in FIG. 2, engaging the threads 14 on the lead screw 12, and a second position, shown in FIG. 3, in which they are disengaged from the lead screw. Springs 64, 66 are located in the housing 20 and bias the first and second lead screw nut parts 50, 52 toward one of the first or second positions. In the illustrated embodiment, the springs 64, 66 bias the first and second lead screw nut parts 50, 52 toward one another to define a lead screw engagement path 58 therebetween. The partial threads 54, 56 engage the threads 14 of the lead screw 12 such that the disengageable lead screw nut assembly 10 can be linearly displaced by the lead screw 12. While the springs 64, 66 can be various types of compression springs, in order to provide a compact arrangement, preferably the springs 64, 66 are wave springs. Wave springs have a wave shaped profile in the circumferential direction and can apply a generally constant force. Alternatively, the springs can be arranged to bias the first and second lead screw nut parts 50, 52 away from one another to the second position, and the electromagnets used to move the first and second lead screw nut parts 50, 52 to the first, engaged position.

The lead screw nut parts 50, 52 are movable upon activation of the electromagnets 40, 42 against the forces of the springs 64, 66 to the other of the first and second positions from the springs 64, 66. In the illustrated embodiment, the electromagnets 40, 42 move the lead screw nut parts 50, 52 from the first, lead screw engagement position, shown in FIG. 2, to the second, disengaged position, shown in FIG. 3, in which the lead screw nut parts 50, 52 are spaced far enough apart such that the threads 14 of the lead screw 12 are disengaged from the partial threads 54, 56 of the lead screw nut parts 50, 52.

Still with reference to FIG. 2, guide pins 68 are preferably mounted in the housing 20, preferably in each of the first and second housing parts 22, 24. Corresponding openings 70 are provided in the lead screw nut parts 50, 52 and the guide pins 68 extend into these openings, defining a movement path for the lead screw nut parts 50, 52 between the first, lead screw engagement position, and the second, disengaged position.

The electromagnets 40, 42 are preferably in the form of solenoids. These can apply an electromagnetic force directly on the first and second lead screw nut parts 50, 52 if they are made of a ferromagnetic material. Alternatively, the first and second lead screw nut parts 50, 52 can be mounted to respective first and second striker plates 60, 62, which are formed of a ferromagnetic material that is attracted by the electromagnets 40, 42 in order to provide for movement of the first and second lead screw nut parts 50, 52 between the first, lead screw engagement position, and the second, disengaged position. The first and second striker plates 60, 62, can be attached to the respective first and second lead screw nut parts 50, 52 by an interference fit, an adhesive, threads, or any other suitable connection.

The springs 64, 66 are located between the first and second lead screw nut parts 50, 52 and at least one of the respective first and second electromagnets 40, 42, portions of the housing parts 22, 24 in which the first and second electromagnets 40, 42, are mounted, or both. As shown in FIG. 2, in one preferred arrangement the springs 64, 66 are located in recesses provided in the electromagnet assemblies.

The housing parts 22, 24 are preferably connected together by fasteners 25, which can be threaded fasteners, in order to allow disassembly of the disengageable lead screw nut assembly 10 for maintenance and/or repair.

The disengageable lead screw nut assembly 10 provides a compact assembly that allows the lead screw 12 to be used for making precise movements while the first and second lead screw nut parts 50, 52 are in the first, lead screw engagement position, and also allows for fast, large scale movement when the lead screw nut parts 50, 52 are in the second, disengaged position.

A lead screw assembly including the disengageable lead screw nut assembly 10 as well as the lead screw 12 is also provided. The disengageable lead screw nut assembly can be provided as a retrofit part for existing linear actuators or linear positioning devices.

Having thus described various embodiments of the present disengageable lead screw nut in detail, it is to be appreciated and will be apparent to those skilled in the art that many physical changes, only a few of which are exemplified in the detailed description above, could be made in the device without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

What is claimed is:

1. A disengageable lead screw nut assembly, comprising:
a housing;
first and second electromagnets mounted on opposing sides of the housing;
first and second lead screw nut parts arranged in proximity to the respective first and second electromagnets, the first and second lead screw nut parts being movable between a first, lead screw engagement position, and a second, disengaged position; and
springs located in the housing that bias the first and second lead screw nut parts toward one of the first and second positions, and the lead screw nut parts are movable against a force of the respective springs to the other of the first and second positions upon activation of the electromagnets, and in the first, lead screw engagement position, a lead screw engagement path is defined between the first and second lead screw nut parts.

2. The disengageable lead screw nut assembly of claim 1, wherein the springs bias the first and second lead screw nut parts to the first, lead screw engagement position and activation of the electromagnets moves the lead screw nut parts to the second, disengaged position.

3. The disengageable lead screw nut assembly of claim 1, further comprising guide pins mounted to the housing, and openings in the lead screw nut parts in which the guide pins extend to define a movement path for the lead screw nut parts between the first, lead screw engagement position, and the second, disengaged position.

4. The disengageable lead screw nut assembly of claim 1, wherein the first and second lead screw nut parts are mounted to respective first and second striker plates which are formed of a ferromagnetic material.

5. The disengageable lead screw nut assembly of claim 1, wherein the springs are wave springs located between the first and second lead screw nut parts and at least one of the respective first and second electromagnets or portions of the housing in which the first and second electromagnets are mounted.

6. The disengageable lead screw nut assembly of claim 1, wherein the housing is comprised of a first housing part and a second housing part that are connected at intermediate faces thereof, the first housing part and the second housing part each including an electromagnet receiving cavity, and a recess to receive the lead screw nut part, and the electromagnets are located in the electromagnet receiving cavities.

7. The disengageable lead screw nut assembly of claim 6, wherein the housing is made of non-ferrous material.

8. The disengageable lead screw nut assembly of claim 6, wherein the housing parts are connected together by fasteners.

9. A lead screw assembly, comprising:
a lead screw; and
a disengageable lead screw nut assembly which includes a housing, first and second electromagnets mounted on opposing sides of the housing, first and second lead screw nut parts arranged in proximity to the respective first and second electromagnets, the first and second lead screw nut parts being movable between a first, lead screw engagement position, and a second, disengaged position; and springs located in the housing that bias the first and second lead screw nut parts toward one of the first and second positions, and the lead screw nut parts are movable against a force of the respective springs to the other of the first and second positions upon activation of the electromagnets, and in the first, lead screw engagement position, a lead screw engagement path is defined between the first and second lead screw nut parts.

10. The lead screw assembly of claim 9, wherein the disengageable lead screw nut assembly further comprises guide pins mounted in the housing, and openings in the lead screw nut parts in which the guide pins extend to define a movement path for the lead screw nut parts between the first, lead screw engagement position, and the second, disengaged position.

11. The lead screw assembly of claim 9, wherein the first and second lead screw nut parts are mounted to respective first and second striker plates which are formed of a ferromagnetic material.

12. The lead screw assembly of claim 9, wherein the springs are wave springs located between the first and second lead screw nut parts and at least one of the respective first and second electromagnets or portions of the housing in which the first and second electromagnets are mounted.

13. The lead screw assembly of claim 9, wherein the housing is comprised of a first housing part and a second housing part that are connected at an intermediate face, the first housing part and the second housing part each including an electromagnet receiving cavity, and a recess to receive the lead screw nut part.

14. The lead screw assembly of claim 13, wherein the housing is made of non-ferrous material.
